(19) United States
(12) Patent Application Publication
(10) Pub. No.: US 2024/0171451 A1
(43) Pub. Date: May 23, 2024

(54) PREVIEWED REACTIONS FOR DISRUPTIVE NETWORK ACTIVITY

(71) Applicant: Cisco Technology, Inc., San Jose, CA (US)

(72) Inventors: Rachana Anubhav Soni, San Ramon, CA (US); David John Zacks, Vancouver (CA)

(21) Appl. No.: 17/989,830

(22) Filed: Nov. 18, 2022

(51) Int. Cl. H04L 41/0631; H04L 41/16; H04L 43/02

(52) U.S. Cl. CPC H04L 41/0645; H04L 41/16; H04L 43/02

(57) ABSTRACT

In one embodiment, a method herein may comprise: determining, by a process, a disruptive activity within a particular computer network of a plurality of computer networks; determining, by the process, telemetry data for the particular computer network, the telemetry data being time-relevant to the disruptive activity; determining, by the process, a set of expected reactions that the particular computer network is expected to experience due to the disruptive activity in correlation to the telemetry data for the particular computer network; and sharing, from the process, the set of expected reactions with a management device of the particular computer network to cause the management device to distinguish between the set of expected reactions and any unexpected events during the disruptive activity.

### TECHNICAL FIELD

The present disclosure relates generally to computer systems, and, more particularly, to previewed reactions for disruptive network activity.

### BACKGROUND

The Internet and the World Wide Web have enabled the proliferation of web services available for virtually all types of businesses. Due to the accompanying complexity of the infrastructure supporting the web services, it is becoming increasingly difficult to maintain the highest level of service performance and user experience to keep up with the increase in web services.

For example, in large data center fabrics involving a huge number of devices, it is very hard to determine the challenges and pitfalls that may be experienced within the fabric, particularly when the fabric is undergoing certain activities such as maintenance windows, device removal/addition, and similar disruptive functions.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example network fabric with analytics applications;

FIG. 4 illustrates an example block diagram of an analytics application and its user interface;

FIG. 5 illustrates an example analytics application user interface page; and

FIG. 6 illustrates an example simplified procedure for previewed reactions for disruptive network activity in accordance with one or more embodiments described herein.

### DESCRIPTION OF EXAMPLE EMBODIMENTS

### Overview

According to one or more embodiments of the disclosure, an illustrative method herein may comprise: determining, by a process, a disruptive activity within a particular computer network of a plurality of computer networks; determining, by the process, telemetry data for the particular computer network, the telemetry data being time-relevant to the disruptive activity; determining, by the process, a set of expected reactions that the particular computer network is expected to experience due to the disruptive activity in correlation to the telemetry data for the particular computer network; and sharing, from the process, the set of expected reactions with a management device of the particular computer network to cause the management device to distinguish between the set of expected reactions and any unexpected events during the disruptive activity.

Other embodiments are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

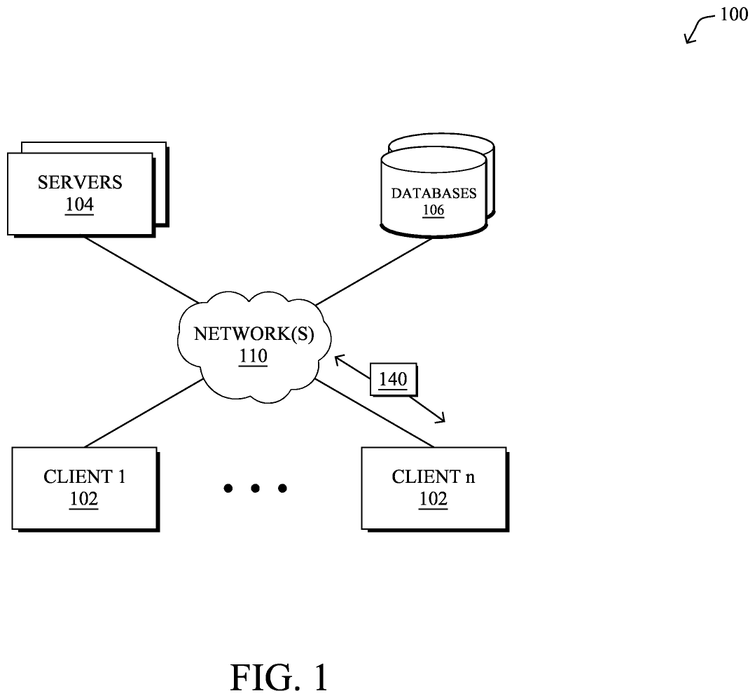

FIG. 1 is a schematic block diagram of an example simplified computing system 100 illustratively comprising any number of client devices 102 (e.g., a first through nth is client device), one or more servers 104, and one or more databases 106, where the devices may be in communication with one another via any number of networks 110. The one or more networks 110 may include, as would be appreciated, any number of specialized networking devices such as routers, switches, access points, etc., interconnected via wired and/or wireless connections. For example, devices 102-104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some embodiments, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the system 100 is merely an example illustration that is not is meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

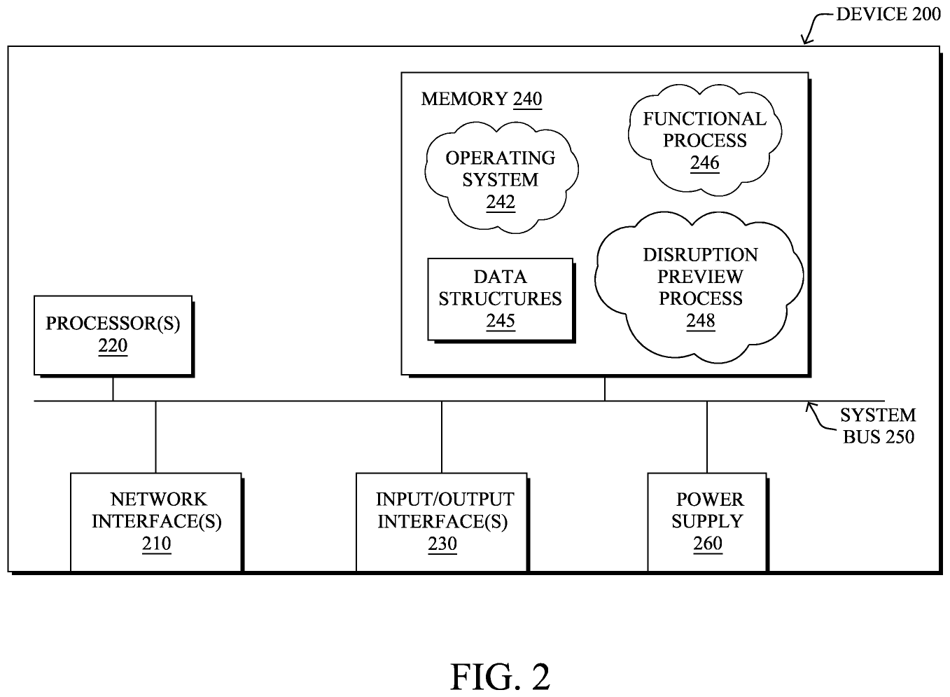

FIG. 2 is a schematic block diagram of an example node/device 200 that may be used with one or more embodiments described herein, e.g., as any of the devices 102-106 shown in FIG. 1 above. Device 200 may comprise one or more network interfaces 210 (e.g., wired, wireless, etc.), at least one processor 220, and a memory 240 interconnected by a system bus 250, as well as a power supply 260 (e.g., battery, plug-in, etc.).

The network interface(s) 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of is network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a one or more functional processes 246, and on certain devices, an illustrative “disruption preview” process 248, as described herein. Notably, functional processes 246, when executed by processor(s) 220, cause each particular device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the is description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

### Previewed Reactions for Disruptive Network Activity

As noted above, it is very hard to determine the challenges and pitfalls that may be experienced in large data center fabrics, particularly when the fabric is undergoing certain activities such as maintenance windows, device removal/addition, and similar disruptive functions. For instance, during disruptive operations, it is extremely hard for a network administrator to select and focus on the “real problems” even though they may be using analytics applications because of the sheer scale of alerts/anomalies/events that arise when such operations are done. In such cases, it would be advantageous for the network operator to be presented with a preview of related anomalies the system would likely go through during the maintenance window or device changes, such that the network operators are not overwhelmed with a flood of anomaly reports and are provided with an enhanced view of what to expect in advance.

The techniques herein, therefore, present a solution which will help determine for network operators the impact of what alerts or issues they can expect to occur as they engage in maintenance or other potentially disruptive activities within their data center fabrics. Said differently, the embodiments herein present a solution which will help determine for network operators what alerts or issues they can expect to occur as they engage in maintenance or other potentially disruptive activities within their data center fabrics before the trigger actually occurs.

Specifically, according to one or more embodiments described herein, an example method herein may comprise: determining a disruptive activity within a particular computer network of a plurality of computer networks; determining telemetry data for the particular computer network, the telemetry data being time-relevant to the disruptive activity; determining a set of expected reactions that the particular computer network is is expected to experience due to the disruptive activity in correlation to the telemetry data for the particular computer network; and sharing the set of expected reactions with a management device of the particular computer network to cause the management device to distinguish between the set of expected reactions and any unexpected events during the disruptive activity.

Notably, the techniques herein may employ any number of machine learning techniques herein. In general, machine learning is concerned with the design and the development of techniques that receive empirical data as input (e.g., collected metric/event data from agents, sensors, etc.) and recognize complex patterns in the input data. For example, some machine learning techniques use an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function is a function of the number of misclassified points. The learning process then operates by adjusting the parameters a,b,c such that the number of misclassified points is minimal. After this optimization/learning phase, the techniques herein can use the model M to classify new data points. Often, M is a statistical model, and the cost function is inversely proportional to the likelihood of M, given the input data.

One class of machine learning techniques that is of particular use herein is clustering. Generally speaking, clustering is a family of techniques that seek to group data according to some typically predefined or otherwise determined notion of similarity.

Also, the performance of a machine learning model can be evaluated in a number of ways based on the number of true positives, false positives, true negatives, and/or false negatives of the model.

In various embodiments, such techniques may employ one or more supervised, unsupervised, or semi-supervised machine learning models. Generally, supervised learning entails the use of a training set of data, as noted above, that is used to train the model to apply labels to the input data. On the other end of the spectrum are is unsupervised techniques that do not require a training set of labels. Notably, while a supervised learning model may look for previously seen patterns that have been labeled as such, an unsupervised model may attempt to analyze the data without applying a label to it. Semi-supervised learning models take a middle ground approach that uses a greatly reduced set of labeled training data.

Example machine learning techniques that the techniques herein can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), multi-layer perceptron (MLP) artificial neural networks (ANNs) (e.g., for non-linear models), replicating reservoir networks (e.g., for non-linear models, typically for time series), random forest classification, or the like.

Operationally, data centers can vary hugely for different customers in terms of number of devices deployed, kinds of configurations, and various use-cases. Analytics applications help the network operator navigate through the system by providing an option to look at different resources, different problems arising in the network, prediction of usage and browsing across the available resources.

As simple as it sounds, looking through all this data on a huge scale and correlating it is a challenge in itself. This means, network operators need to spend cycles and time in understanding what information these analytics applications provide and then make sense out of it. The problem becomes even more difficult when the system is undergoing time-critical triggers, based on maintenance or other potentially disruptive activities. It then becomes very critical for the network operators to know exactly what the system is going through, and whether events/alerts shown by the analytics applications are expected or unexpected.

As noted above, the techniques herein therefore propose a solution where network is operators can get a preview of foreseeable events/alerts/anomalies their system may experience in case of triggers such as maintenance windows, device addition/removal, and/or configuration addition/removal. This will help determine foreseeable issues with their system during triggers sooner and with a reference baseline. In addition to this, certain embodiments herein may narrow down the alerts/events/anomalies dataset for the operator by being able to distinguish and mark the newer alerts/events/anomalies in comparison to what previously existed on the system before disruptive trigger.

Analytics applications today already collect many types of telemetry data from the devices in the fabric. The challenge in solving this problem is to determine how to provide the customers with a preview of foreseeable events/alerts/anomalies based on the activities they are undertaking—keeping in mind the privacy of customer data. In order to solve this problem, the techniques herein propose certain criteria that would be the defining parameters for what this preview would look like. The criteria can be broadly grouped into following:
Scope and scale attributes (does not contain much personally identifying information, “PII”);
Resources attributes (does not contain much PII);
Hardware (e.g., ternary content addressable memory or “TCAM”, Quality of Service or “QoS”, forwarding tables, etc.);
Software capacity (e.g., CPU, memory utilization, etc.);
Criteria specific to that proprietary site (e.g., IP addresses, MAC addresses, vLAN, subnets, etc.).

To further illustrate this, assume in the following example, where a given fabric (spine-leaf architecture) has ten (10) spines and twenty (20) leafs, with <x> number of Bridge Domains (BDs), <y> number of virtual routing and forwarding (VRFs), and <z> number of endpoints with ten (10) virtual machines (VMs) each as end hosts. If this customer is undergoing (for example) upgrades of switch software on all twenty leafs, a possible set of criteria in this situation could be (but not limited to the following):
Spines;
Leafs;
BDs/VRFs;
Endpoints;
End-hosts;
Software versions;
Hardware versions; and
Types of applications.

The above specific criteria, for instance, may have been selected because they do not contain customer PII (Privately or Personally Identifiable Information). Different criteria are also possible for use with the techniques herein, and the above are merely one illustrative example.

According to this example, then, illustrative parameters for what this preview would include may then would be:
Number of spines;
Number of leafs;
Number of BDs/VRFs;
Number of endpoints;
Number of end-hosts;
Software version specification;
Hardware version specification; and
Configurations (within the limits of data sharing possible/permitted by the customer).

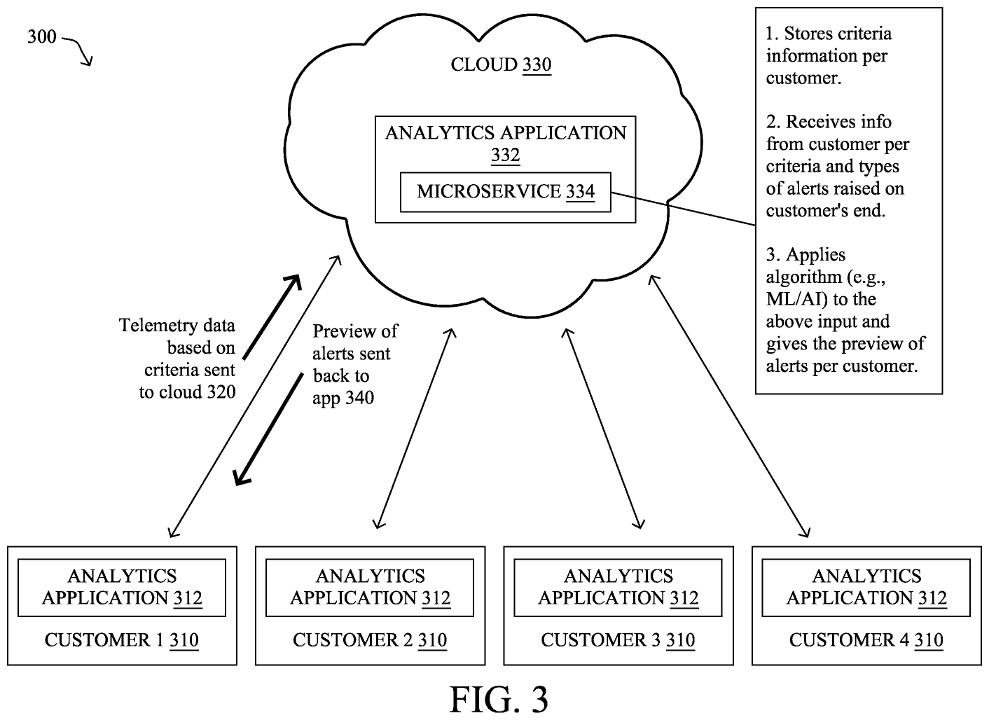

As shown in network fabric 300 of FIG. 3, when an analytics application 312 is is deployed at customers 310 (e.g., “Customer 1”, “Customer 2”, etc.) in such fabrics, these analytics applications can export these elements of high-level data (parameters), i.e., telemetry data 320 corresponding to the above criteria, to a cloud instance 330 (e.g., analytics application 322 of the cloud instance), where such data 320 also includes the events/alerts high-level information from the analytics application 312 the system experiences during such triggers. For example, such an alert may contain information such as “severity” (e.g., major, minor, critical, warning, etc.), “category” (e.g., interface, node, etc.), “title” (e.g., “interface down”, “delay”, etc.), “count” (e.g., number of occurrences of the alert), “description” (e.g., “interface is down”, “max delay exceeded”, “packet drops sharply rising”, etc.), and so on. Other types of information may be included (or excluded), and those listed herein are merely one example embodiment of the techniques herein.

The cloud instance (analytics application 332) runs a separate microservice 334 which is capturing this kind of data from all the customers 310, thus, becoming a data lake of alerts/events/anomalies from across the customers. The telemetry data 320 based on the above criteria is sent from the customer running analytics application 312 to the cloud instance where it gets matched against the best possible fit from the data lake, e.g., using AI/ML algorithms, and returns back a report or “preview” 340 described herein that consists of events/alerts/anomalies.

According to the techniques herein, the customer application 312 captures a snapshot of an existing state of alerts/events/anomalies on the system, such as periodically, in response to a specific request, in response to one or more triggers, and so on. Once the preview results 340 are received from cloud application 332, a difference between the snapshot of existing state on the local system and the preview results is taken to narrow down the alerts/events/anomalies that may actually need an operator's attention for that particular customer.

The following example further illustrates the concepts herein. For instance, assume the following alert list data 320 being sent to the cloud application 332 from each of the customers 310:
customer 1: [A1, A2, A3, A4, A5];
customer 2: [A6, A7, A3, A4, A5];
customer 3: [A1, A2, A8, A9, A5]; and
customer 4: [A1, A2, A3, A4, A10].

Also assume that customer 1's snapshot of the alert list (current state of the system) is still: [A1, A2, A3, A4, A5]. Now suppose for customer 1 that the cloud returns back the preview results as the following list: [A1, A2, A3, A4, A5, A6, A7, A8, A9, A10]. By taking the difference between the snapshot of the current state against the preview results, the expected alert list delta is [A6, A7, A8, A9, A10].

Now, although the preview results for customer 1 are [A1 through A10], the techniques herein may also mark alerts [A6 to A10] with some distinction that these are brand new alerts that can potentially be foreseen on customer 1's system when it undergoes the particular disruptive activity.

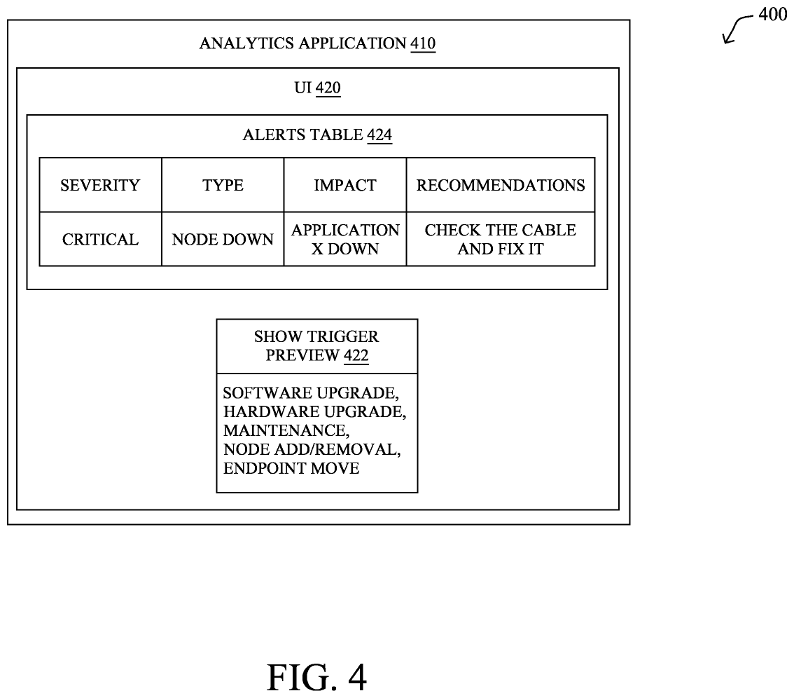

In one or more embodiments herein, a preview tab within a user interface (UI) may list all alerts from A1 to A10 with a special marking for A6 to A10, and may also provide an up/down vote option next to each of these alerts to capture user input on their relevance to be used for further iterations. For instance, as shown in FIG. 4, a block diagram 400 of an analytics application 410 and its user interface 420 illustrate a preview tab 422 where certain trigger previews can be shown, such as, e.g., software upgrades, hardware upgrades, maintenance, node addition/removal, endpoint moves, etc. An alerts table 424 then shows an example of certain alerts and various information, such as severity, type, impact, recommendations, etc.

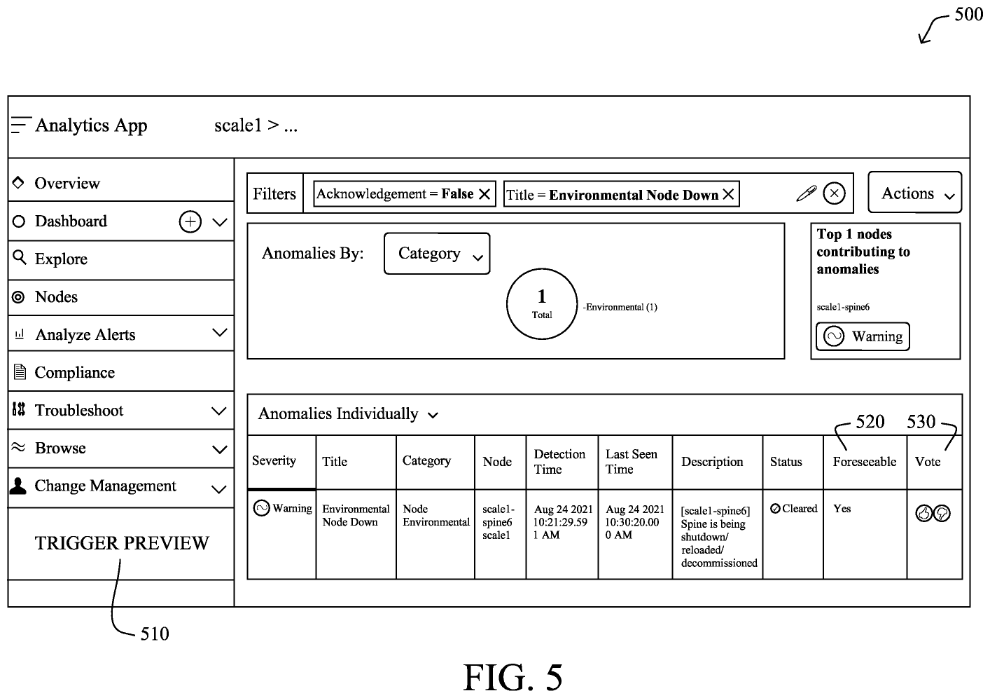

FIG. 5, in addition, illustrates an example analytics application UI page 500 is illustrating certain specific concepts described herein. For example, a “trigger preview” tab 510 may be presented within a menu of options, and within information about a particular alert/event/anomaly, the techniques herein may provide new fields, such as a “foreseeable” field 520 to indicate whether the particular alert/event/anomaly was foreseeable or not, and a “vote” field 530 to allow for simple up/down voting of the foreseeability of the particular alert/event/anomaly, as described herein. (Note that other representations, arrangements, configurations, and so on may be available through any suitably designed user interface, and the view shown herein is merely an example for illustration to be understood by those skilled in the art.)

Furthermore, with machine learning algorithms, the techniques herein can refine the preview results using the alerts/events/anomalies based on the above criteria for this customer (e.g., customer 1) compared to the high-level data gathered from customers with similar matching criteria (e.g., customers 3 and 4) as shown above. This way, when the customer is about to implement certain updates or changes in their environment, they can click on “show preview” (e.g., the “trigger preview” tab 510) and see the projected likely events/alerts that the techniques herein predicts that they will experience. Also, to make the results more relevant for each customer, user input captured in the form of up or down vote buttons against each of the alerts/events/anomalies (which is likely coming from their system) can be used as an input to A1/ML algorithms in future iterations of previews.

Notably, previews are gathered based on stating criteria, matching the profile data stored in the cloud, and returning the results of any relevant matches. These matches are not intended to be 100% complete and exhaustive—rather, they are intended to provide a significantly better understanding to the network operators than they would otherwise have of what the system may be undergoing during the upcoming planned events.

Once the trigger has started and events/alerts begin to appear, the techniques herein mark the ones that were projected as part of the preview as “foreseeable”. This will help the network operators to know that the changes, although they may be introducing some network disruption, are running successfully, and generating the possible is foreseeable events/alerts/anomalies. Also, this helps identify the network operators which events/alerts/anomalies needs to be closely looked at which were not present in the preview (e.g., an “A11” or “A12”, etc.)—and which may thus be unintended—hence helping save time and allowing the operators to focus their attention on the actual issues which require it.

Since the criteria are high level information with regard to customer datacenter fabrics, the preview would be an approximation of the events/alerts/anomalies that may be experienced, and the actual system operation when undergoing maintenance or other similar actions may show more event/alerts/anomalies in addition to the ones showed in preview to the network operator. However, as systems operating according to the techniques herein may be continuously exposed to multiple customer environments, the preview feature with the help of machine learning algorithms would be refined with additional use and data, and will be able to provide a more refined set of results as time goes on.

Note further that in one embodiment, the use and aggregation of data securely across multiple customers using a cloud instance of the invention would be foreseen. This has the added benefit that the ML-based system can become more effective over time based on exposure to multiple, similar customer environments. An additional embodiment, however, is local (on-prem) only, such as for use in cases where customer constraints dictate that a cloud instance cannot be employed. In such a case, ML-based learning herein may be limited to the customer's local data set only, or to a distilled version of aggregated data.

As another example of the techniques herein for further clarity, assume that there is an analytics application that already is monitoring devices. This analytics application already has an alert raising system in place which raises alerts for interfaces, devices going down, flows getting dropped, endpoints moving, etc. Accordingly, when everything is “up and running” in a cluster, the system is clean and likely there are not many alerts.

Now, after several iterations of the system's disruptive upgrade, the number of alerts raised during that time are sent to the microservice running in the cloud. This can be termed as a training data set for the ML algorithm. So, for example, assume a customer experiences certain during the disruptive period over several iterations. Then this list is sent to the cloud from that customer. Also, the other telemetry data with regard to parameters (such as #spines, #leafs, #BDs, #vrfs, #endpoints, etc.) is sent to the cloud regularly depending on the network changes.

The microservice running in the cloud is already gathering such data from the other customers. Using a supervised machine learning algorithm, based on the dataset coming from all the customers and customer specific configuration that was streamed upwards such as (#spines, #leafs, #BDs, #vrfs, #endpoints, etc.), a list of alerts are identified for this customer that potentially could occur on their system. This list of alerts is the preview for that customer.

Now when the user is planning to upgrade this device in the production environment (assuming there is no alternate path for it), they generally would like to see what is going to be the impact of this operation. Hence, based on the above parameters of the preview (such as #spines, #leafs, #BDs, #vrfs, #endpoints, etc.), the techniques herein provide the preview of all alerts that may be expected to happen on this node when it undergoes an upgrade.

Now say, as part of a preview, expected reactions (e.g., alerts) that were returned were R1, R2, R3, R4, and R5. The user now has an idea of these alerts, and thereafter decides to undergo an upgrade. During the actual upgrade on this device, assume for example that reactions that occur are R1, R2, R3, R4, R5, R6, R7, R8, R9, and R10.

According to the techniques herein, when the reactions (e.g., alerts) are shown on the dashboard, R1-R5 will be marked as expected. As such, when the user applies a time range filter for when that device was upgraded and node filter, they'd see all ten alerts (R1-R10), but with R1-R5 marked as expected alerts, and the remaining R6-R10 can be is seen as something unexpected. This thus makes it easier for the user to distinguish which reactions/alerts are the ones that need their attention (e.g., visually, though filtering or sorting mechanisms, and so on).

As also noted above, by providing a “thumbs up/down” button on the alerts page next to each alert, the user can provide their input to these alerts if they are relevant to this system/cluster setup, thus making a stronger case for some particular alerts. In the next iteration of a system upgrade, therefore, the ML algorithm herein may thus know, for example, that R1-R5 alerts for the customer's preview were “ok′ed” by the user, which can help refine the next set of predictions.

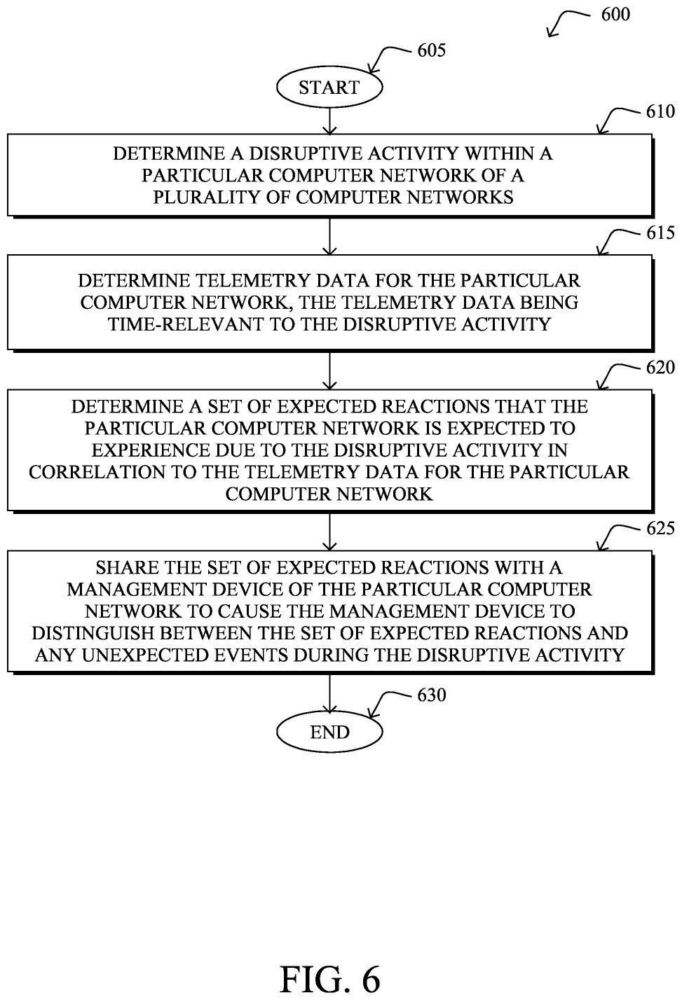

In closing, FIG. 6 illustrates an example simplified procedure for previewed reactions for disruptive network activity in accordance with one or more embodiments described herein, particularly from the perspective of the cloud application/microservice described above. For example, a non-generic, specifically configured device (e.g., device 200, e.g., cloud server, or otherwise) may perform procedure 600 by executing stored instructions (e.g., process 248). The procedure 600 may start at step 605, and continues to step 610, where, as described in greater detail above, the techniques herein determine a disruptive activity (e.g., an upcoming disruptive activity) within a particular computer network (e.g., a data center of a particular customer network) of a plurality of computer networks. In addition, in step 615, the techniques herein further determine telemetry data (e.g., customer-specific telemetry data) for the particular computer network, the telemetry data being time-relevant to the disruptive activity. Note that in one embodiment herein, the techniques herein may specifically include determining “pre-indicators” of the disruptive activity, and thus triggering a request to obtain the telemetry data for the particular computer network in response to such pre-indicators prior to occurrence of the disruptive activity (e.g., selection of the preview tab, potentially oncoming problems such as reaching limits/thresholds, and so on).

In step 620, the techniques herein may then determine a set of expected reactions (e.g., alerts, alarms, anomalies, etc.) that the particular computer network is expected to experience due to the disruptive activity in correlation to the telemetry data for the particular computer network. As detailed above, this may be based on a machine learning model, particularly refined by performing feedback loop training of the machine learning model (e.g., manual up/down voting, or otherwise). As also detailed above, expected reactions may be based on learning similar reactions experienced due to similar disruptive activity from one or more other similar computer networks. For example, as mentioned, by capturing data of alerts and configuration parameters from all the customers, the techniques herein can define a “superset” of possible expected reactions/alerts that potentially may happen on a given system, even if so far that system has not seen them before (e.g., “these may happen on your system, but if not, you can ignore their inclusion in this preview”).

In step 625, the techniques herein may then share the set of expected reactions with a management device of the particular computer network (e.g., the analytics application 312 of the customer 310) to cause the management device to distinguish between the set of expected reactions and any unexpected events during the disruptive activity (e.g., on a graphical user interface associated with the analytics application, or otherwise for non-manual processes, such as automated anomaly detection software, etc.). Note specifically that the set of expected reactions may be shared with the management device prior to the upcoming disruptive activity to be able to “manage expectations”, or else afterward in order to allow filtering of the reactions, accordingly.

The simplified procedure 600 may then end in step 630, notably with the ability to continue collecting data, refining models, distributing previews, and so on. Other steps may also be included generally within procedure 600. For example, such steps (or, more generally, such additions to steps already specifically illustrated above), may include other features and/or operations described in greater detail above.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the is embodiments herein.

The techniques described herein, therefore, provide for previewed reactions for disruptive network activity. In particular, the techniques herein allow a network operator to be able to preview the anomalies/alerts/events a given system will go through before it actually experiences them during the disruptive triggers. This in return will then help the network operators filter out the actual issues that need attention. That is, the techniques herein improve the ease of use of analytics applications during the triggers, saving time by focusing investigation into critical issues that actually need network operator attention, rather than scanning through expected reactions. For example, out of a list of 100 alerts, there may only be five that an admin might care about seeing, since these five are the ones they weren't already expecting to see. For instance, during a reboot process, many “interface down/up” messages would be expected, but a firmware upgrade on a card, perhaps, may not have been expected during a reboot.

Moreover, with more triggers and events being accumulated by the system, the AI/ML algorithms would refine the results of expected alerts more closely to what the system is actually undergoing during such events—becoming “smarter” over time. Up/down voting further refines the results when an admin says whether or not they saw the expected error, or whether or not a reaction should have actually been expected.

Note, too, that the techniques herein use existing data from similar matching customers to yield the results of a preview. No other analytics applications are currently capable of combining the data from different customers to be able to get such a preview for disruptive activities that their system undergoes.

The techniques herein, in particular, are applicable to cases where it is not possible to take down the device out of production network, or where certain production environments do not have alternate paths. For example, if an upgrade is done on an edge switch, there may not be an alternate path, and the device needs to be upgraded while in the production environment. Further, even if there is alternate path, one would still want is to know how the device actually responded to the disruptive activity, specifically the delta as opposed to how it was expected to respond.

Also worth mentioning, about 30% of the outages in any IT environment are related to so-called “change requests” (CR) or change management issues. The change management performed by unexperienced engineer can result into major outage and since there is often no reputational information about the engineer performing the CR, these outages are not rare, therefore the problem is real.

Illustratively, the techniques described herein may be performed by hardware, software, and/or firmware, such as in accordance with the illustrative disruption preview process 248, which may include computer executable instructions executed by the processor 220 to perform functions relating to the techniques described herein, e.g., in conjunction with corresponding processes of other devices in the computer network as described herein (e.g., on network agents, controllers, computing devices, servers, etc.). In addition, the components herein may be implemented on a singular device or in a distributed manner, in which case the combination of executing devices can be viewed as their own singular “device” for purposes of executing the process 248.

According to the embodiments herein, an illustrative method herein may comprise: determining, by a process, a disruptive activity within a particular computer network of a plurality of computer networks; determining, by the process, telemetry data for the particular computer network, the telemetry data being time-relevant to the disruptive activity; determining, by the process, a set of expected reactions that the particular computer network is expected to experience due to the disruptive activity in correlation to the telemetry data for the particular computer network; and sharing, from the process, the set of expected reactions with a management device of the particular computer network to cause the management device to distinguish between the set of expected reactions and any unexpected events during the disruptive activity.

In one embodiment, the disruptive activity is an upcoming disruptive activity. In one embodiment, sharing the set of expected reactions with a management device of the particular computer network occurs prior to the upcoming disruptive activity.

In one embodiment, the particular computer network comprises a data center.

In one embodiment, the particular computer network comprises a particular customer network. In one embodiment, the telemetry data comprises customer-specific telemetry data.

In one embodiment, the set of expected reactions comprise one or more of alerts, alarms, and anomalies.

In one embodiment, determining the set of expected reactions that the particular computer network is expected to experience due to the disruptive activity is based on a machine learning model. In one embodiment, the method further comprises: performing feedback loop training of the machine learning model. In one embodiment, feedback loop training comprises manual up-voting and down-voting.

In one embodiment, the method further comprises: learning similar reactions experienced due to similar disruptive activity from one or more other similar computer networks, wherein the similar reactions from other similar computer networks are used in part determine the set of expected reactions that the particular computer network is expected to experience.

In one embodiment, the method further comprises: determining one or more pre-indicators of the disruptive activity within the particular computer network; and triggering a request to obtain the telemetry data for the particular computer network in response to the one or more pre-indicators prior to occurrence of the disruptive activity.

According to the embodiments herein, an illustrative tangible, non-transitory, computer-readable medium herein may have computer-executable instructions stored thereon that, when executed by a processor on a computer, may cause the computer to perform a method comprising: determining a disruptive activity within a particular computer network of a plurality of computer networks; determining telemetry data for the particular computer network, the telemetry data being time-relevant to the disruptive activity; determining a set of expected reactions that the particular computer network is is expected to experience due to the disruptive activity in correlation to the telemetry data for the particular computer network; and sharing the set of expected reactions with a management device of the particular computer network to cause the management device to distinguish between the set of expected reactions and any unexpected events during the disruptive activity.

Further, according to the embodiments herein an illustrative apparatus herein may comprise: one or more network interfaces to communicate with a network; a processor coupled to the network interfaces and configured to execute one or more processes; and a memory configured to store a process that is executable by the processor, the process, when executed, configured to: determine a disruptive activity within a particular computer network of a plurality of computer networks; determine telemetry data for the particular computer network, the telemetry data being time-relevant to the disruptive activity; determine a set of expected reactions that the particular computer network is expected to experience due to the disruptive activity in correlation to the telemetry data for the particular computer network; and share the set of expected reactions with a management device of the particular computer network to cause the management device to distinguish between the set of expected reactions and any unexpected events during the disruptive activity.

While there have been shown and described illustrative embodiments above, it is to be understood that various other adaptations and modifications may be made within the scope of the embodiments herein. For example, while certain embodiments are described herein with respect to certain types of networks in particular, the techniques are not limited as such and may be used with any computer network, generally, in other embodiments. Moreover, while specific technologies, protocols, and associated devices have been shown, such as Java, TCP, IP, and so on, other suitable technologies, protocols, and associated devices may be used in accordance with the techniques described above. In addition, while certain devices are shown, and with certain functionality being performed on certain devices, other suitable devices and process locations may be used, accordingly. That is, the embodiments have been shown and is described herein with relation to specific network configurations (orientations, topologies, protocols, terminology, processing locations, etc.). However, the embodiments in their broader sense are not as limited, and may, in fact, be used with other types of networks, protocols, and configurations.

Moreover, while the present disclosure contains many other specifics, these should not be construed as limitations on the scope of any embodiment or of what may be claimed, but rather as descriptions of features that may be specific to particular embodiments of particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on is a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true intent and scope of the embodiments herein.

1. A method, comprising:
determining, by a device in communication with a plurality of computer networks, a disruptive activity within a particular computer network of the plurality of computer networks;
determining, by the device, telemetry data for the particular computer network, the telemetry data being time-relevant to the disruptive activity;
determining, by the device, a set of expected reactions that the particular computer network is expected to experience due to the disruptive activity in correlation to the telemetry data for the particular computer network; and
sharing, from the device, the set of expected reactions with a management device of the particular computer network to cause the management device to distinguish between the set of expected reactions and any unexpected events during the disruptive activity.

2. The method as in claim 1, wherein the disruptive activity is an upcoming disruptive activity.

3. The method as in claim 2, wherein sharing the set of expected reactions with a management device of the particular computer network occurs prior to the upcoming disruptive activity.

4. The method as in claim 1, wherein the particular computer network comprises a data center.

5. The method as in claim 1, wherein the particular computer network comprises a particular customer network.

6. The method as in claim 5, wherein the telemetry data comprises customer-specific telemetry data.

7. The method as in claim 1, wherein the set of expected reactions comprise one or more of alerts, alarms, and anomalies.

8. The method as in claim 1, wherein determining the set of expected reactions that the particular computer network is expected to experience due to the disruptive activity is based on a machine learning model.

9. The method as in claim 8, further comprising:
performing feedback loop training of the machine learning model.

10. The method as in claim 9, wherein feedback loop training comprises manual up-voting and down-voting.

11. The method as in claim 1, further comprising:
learning similar reactions experienced due to similar disruptive activity from one or more other similar computer networks, wherein the similar reactions from other similar computer networks are used in part determine the set of expected reactions that the particular computer network is expected to experience.

12. The method as in claim 1, further comprising:
determining one or more pre-indicators of the disruptive activity within the particular computer network; and
triggering a request to obtain the telemetry data for the particular computer network in response to the one or more pre-indicators prior to occurrence of the disruptive activity.

13. A tangible, non-transitory, computer-readable medium having computer-executable instructions stored thereon that, when executed by a processor on a computer, cause the computer to perform a method comprising:
determining a disruptive activity within a particular computer network of a plurality of computer networks;
determining telemetry data for the particular computer network, the telemetry data being time-relevant to the disruptive activity;
determining a set of expected reactions that the particular computer network is expected to experience due to the disruptive activity in correlation to the telemetry data for the particular computer network; and
sharing the set of expected reactions with a management device of the particular computer network to cause the management device to distinguish between the set of expected reactions and any unexpected events during the disruptive activity.

14. The tangible, non-transitory, computer-readable medium as in claim 13, wherein the disruptive activity is an upcoming disruptive activity.

15. The tangible, non-transitory, computer-readable medium as in claim 14, wherein sharing the set of expected reactions with a management device of the particular computer network occurs prior to the upcoming disruptive activity.

16. The tangible, non-transitory, computer-readable medium as in claim 13, wherein determining the set of expected reactions that the particular computer network is expected to experience due to the disruptive activity is based on a machine learning model.

17. The tangible, non-transitory, computer-readable medium as in claim 16, wherein the method further comprises:
performing feedback loop training of the machine learning model.

18. The tangible, non-transitory, computer-readable medium as in claim 13, wherein the method further comprises:
learning similar reactions experienced due to similar disruptive activity from one or more other similar computer networks, wherein the similar reactions from other similar computer networks are used in part determine the set of expected reactions that the particular computer network is expected to experience.

19. The tangible, non-transitory, computer-readable medium as in claim 13, wherein the method further comprises:
determining one or more pre-indicators of the disruptive activity within the particular computer network; and
triggering a request to obtain the telemetry data for the particular computer network in response to the one or more pre-indicators prior to occurrence of the disruptive activity.

20. An apparatus, comprising:
one or more network interfaces to communicate with a network;
a processor coupled to the one or more network interfaces and configured to execute one or more processes; and
a memory configured to store a process that is executable by the processor, the process, when executed, configured to:
determine a disruptive activity within a particular computer network of a plurality of computer networks;
determine telemetry data for the particular computer network, the telemetry data being time-relevant to the disruptive activity;
determine a set of expected reactions that the particular computer network is expected to experience due to the disruptive activity in correlation to the telemetry data for the particular computer network; and
share the set of expected reactions with a management device of the particular computer network to cause the management device to distinguish between the set of expected reactions and any unexpected events during the disruptive activity.
